(19) United States
(12) Patent Application Publication
(10) Pub. No.: US 2018/0174114 A1
(43) Pub. Date: Jun. 21, 2018

(54) LIFECYCLE TRACKING FOR MACHINE COMPONENTS

(71) Applicant: Caterpillar Inc., Peoria, IL (US)

(72) Inventors: Vincent John Neyens, Peoria, IL (US); Darren Oliver Gordon O'Reilly, Dunlap, IL (US)

(73) Assignee: Caterpillar Inc., Peoria, IL (US)

(21) Appl. No.: 15/380,777

(22) Filed: Dec. 15, 2016

(51) Int. Cl. G06Q 10/00

(52) U.S. Cl. CPC G06Q 10/20

(57) ABSTRACT

A system for tracking components of a machine and a method for tracking the lifecycle of a component for a machine is provided. The system may have an electronic chip having a serial number, wherein the electronic chip is integrated within a component of the machine. The system may also have a communication module operatively connected to the electronic chip via a communication bus and a transmitter module operatively connected to the communication module. The communication module may read the serial number of the electronic chip and the transmitter module transmits the serial number to a central database, causing the central database to associate the serial number and the component to the machine.

### TECHNICAL FIELD

The present disclosure generally relates to lifecycle tracking systems and methods. More particularly, the present disclosure relates to a lifecycle tracking systems and methods for machine components.

### BACKGROUND

Proper maintenance of machines can help ensure more reliable, safer, and longer performance. A machine manufacturer often provides a recommended maintenance schedule for their machine, but implementing and following the recommended maintenance schedule can be a challenge. Some systems for helping track vehicle maintenance have been developed. One system for tracking vehicle maintenance using sensor detection is described in U.S. Pat. No. 8,311,698 (the '698 patent) assigned to International Business Machines (IBM), which issued on Nov. 13, 2012. The '698 patent describes using radio frequency identification in cooperation with a computer system aboard a motor vehicle to track service and maintenance activities relating to the vehicle. Although the system of the '698 patent may provide a way of tracking some components of a vehicle, it may be less than optimal, for example, due to the limitations and requirements associated with radio frequency identification devices.

The disclosed system is directed to overcoming one or more of the problems set forth above and/or other problems of the prior art.

### SUMMARY

In one aspect, the present disclosure is directed to a system for tracking components of a machine. The system may include an electronic chip having a serial number, wherein the electronic chip is integrated within a component of the machine. The system may also include a communication module operatively connected to the electronic chip via a communication bus and a transmitter module operatively connected to the communication module. The communication module may read the serial number of the electronic chip and the transmitter module may transmit the serial number to a central database, causing the central database to associate the serial number and the component to the machine.

In another aspect, the present disclosure is directed to a method for tracking the lifecycle of a component for a machine. The method may include assigning a serial number to the component by integrating an electronic chip having the serial number into the component. The method may also include associating manufacturing data of the component to the serial number as part of the manufacturing process for the component. The method may further include associating end user data of the component to the serial number as part of the installation process for the component. The method may also include collecting the manufacturing data and the end user data of the component in a central database, causing the central database to associate the serial number, the manufacturing data, and the end user data with the machine.

In another aspect, the present disclosure is directed to a method for tracking components of a machine. The method may include connecting an electronic chip to a communication module via a communication bus, wherein the electronic chip has a serial number and is integrated with a component of the machine. The method may also include reading the serial number of the electronic chip via the communication module and transmitting the serial number to a central database via a transmitter module that is operatively connected to the communication module, causing the central database to associate the serial number and the component to the machine.

Other features and aspects of this disclosure will be apparent from the following description and the accompanying drawings.

### BRIEF DESCRIPTION OF THE DRAWINGS

FIG. 1 is a side-view illustration of an exemplary disclosed machine;

FIG. 2 is a schematic of a tracking system for tracking components of the machine of FIG. 1;

FIG. 3 is a schematic of an electronic chip of the tracking system of FIG. 2;

FIG. 4 is a schematic illustration a representative lifecycle for an exemplary component of the machine of FIG. 1; and

FIG. 5 is a flowchart depicting an exemplary method for tracking the lifecycle of the component of FIG. 4.

### DETAILED DESCRIPTION

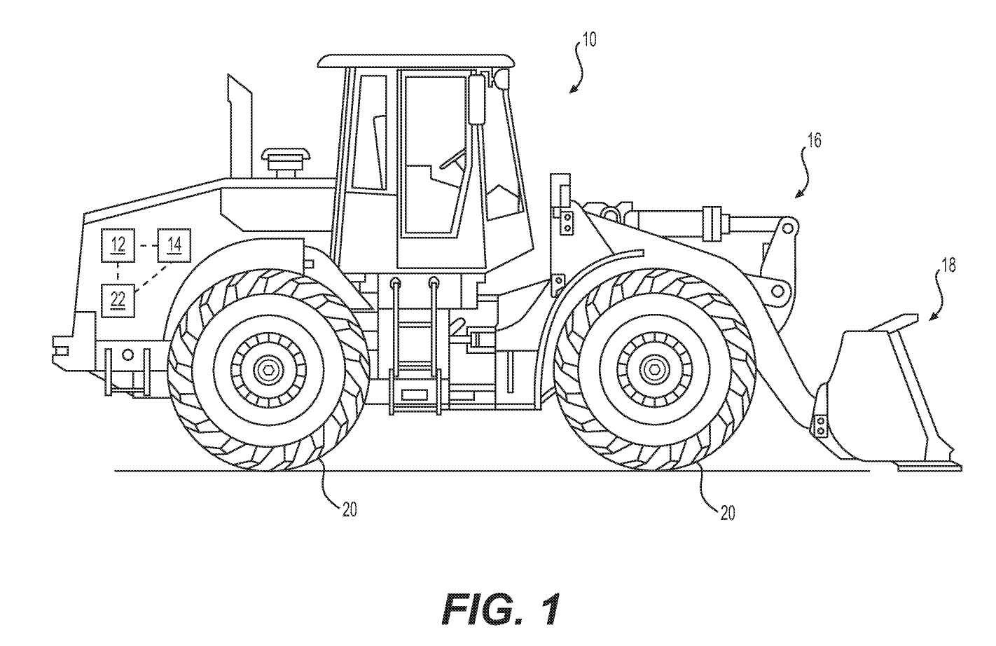

FIG. 1 illustrates an exemplary embodiment of a machine 10. Machine 10 may be, for example, a machine that performs some type of operation associated with an industry such as mining, construction, farming, transportation, or any other industry known in the art. Machine 10 may be an earth moving machine such as a loader, as illustrated in FIG. 1. Although machine 10 is embodied as a loader in the illustrated embodiment of FIG. 1, it will be appreciated that the embodiments of the present disclosure are equally applicable to other types of non-mobile machines (e.g., generators, pumps, etc.) or mobile machines such as, for example, but not limited to, trucks, shovels, diggers, buckets, hydraulic excavators, motor graders, and the like. Therefore, notwithstanding any particular configuration of machine disclosed in this document, it may be noted that embodiments disclosed herein can be similarly applied to other types of machines and their components without deviating from the spirit of the present disclosure.

Machine 10 may include, among other things, a drive system 12, a transmission system 14, an articulation system 16, a work implement 18 (e.g., a bucket), and multiple ground engaging members. The ground engaging members may be in the form of tracks for a track-type machine or a set of wheels 20, as illustrated in FIG. 1. Drive system 12 may include an engine (not shown). Transmission system 14 may include gears, differential systems, axles, and other components (not shown) that are coupled to drive system 12 and wheels 20 of machine 10. Transmission system 14 may be configured to transfer power from drive system 12 to wheels 20 in order to drive machine 10. Articulation system 16 may be operatively coupled to work implement 18. Articulation system 16 may include hydraulically actuated linkages that enable articulation of work implement 18 during operation. Work implement 18 may operatively perform functions such as, but not limited to, hauling and dumping materials.

Machine 10 may also include a tracking system 22, according to an exemplary embodiment. Tracking system 22 may interface with various systems (e.g., drive system 12, transmission system 14, articulation system 16, work implement 18, wheels 20, etc.) of machine 10 and one or more components within the various systems. As described herein, tracking system 22 may collect and track information on various components of machine 10.

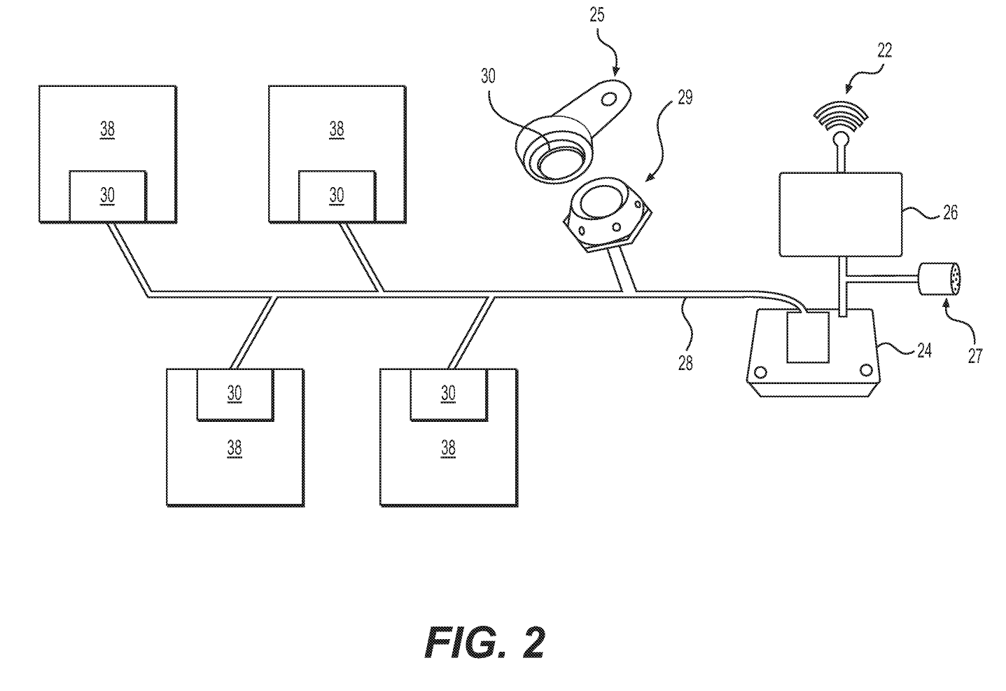

A schematic representation of tracking system 22 is illustrated in FIG. 2. Tracking system 22 may include a communication module 24, a transmitter module 26, and a communication bus (e.g., a one-wire bus 28) configured to communicably couple communication module 24 to one or more electronic chips 30. One-wire bus 28 may be integrated throughout the various systems of machine 10. As will be described in further detail herein, an electronic chip 30 may be integrated into a plurality of components 38 of machine 10. As illustrated in FIG. 2, the plurality of electronic chips 30 integrated into the plurality of components 38 may be operatively connected to one-wire bus 28 enabling communication with communication module 24. In some embodiments up to 64 different electronic chips 30 may be connected to one-wire bus 28 and a length of one-wire bus 28 may extend up to about 300 feet. The plurality of electronic chips 30, one-wire bus 28, communication module 24, and transmitter module 26 may form a network over which data may be transmitted.

In some embodiments, machine 10 may have component specific mounting bases (not shown) that are designed to facilitate installation of a component 38 on machine 10 while concurrently connecting the electronic chip 30 integrated within the component 38 to one-wire bus 28. In some embodiments, as shown in FIG. 2, tracking system 22 may also include a service connection port 27, which may be designed to enable a service technician easy connection to one-wire bus 28 in order to run diagnostics or conduct other service related activities. In some embodiments, as shown in FIG. 2, tracking system 22 may also include a personnel identifier port 29. Personnel identifier port 29 may be designed to connect with an electronic chip 30 assigned to an individual person (e.g., service technician or operator) in order to identify that individual when they are working with (e.g., servicing or operating) machine 10. In some embodiments, the electronic chip 30 may be integrated into a keychain fob 25, which the service technician or operator may carry.

One-wire bus 28 may be configured to use a single data line plus a ground reference for communication. Tracking system 22 may use serial protocol for communication between communication module 24 and electronic chips 30. Communication module 24 may function as a master device, which may initiate and control communication with electronic chips 30 functioning as slave devices. Electronic chips 30 may operate over a low voltage range (e.g., between about 2.8 V and 5.25 V). Disconnecting an electronic chip 30 from the one wire bus or loss of contact with one-wire bus 28 will cause the electronic chip 30 to enter a defined reset state. When the voltage returns, the electronic chip 30 will wake up and may signal its presence on one-wire bus 28 to communication module 24. It is contemplated that for some embodiments suitable alternative communication buses to one-wire bus 28 may be utilized, including for example, a serial peripheral interface bus (SPI), a controller area network (CAN), or the like.

Communication module 24 may include an electronic control module, controller, processor, or other computing device(s) comprising various combinations of one or more Application Specific Integrated Circuit(s) (ASIC), Field-Programmable Gate Arrays (FPGA), electronic circuit(s), central processing unit(s), microprocessor(s) and associated memory and storage (read only, programmable read only, random access, hard drive, etc.) executing one or more software or firmware programs, combinational logic circuit(s), input/output circuit(s) and devices, appropriate signal conditioning and buffer circuitry, and other suitable components to provide the described functionality.

Communication module 24 may be configured to initiate activity on one-wire bus 28. Communication module 24 may be programmed to use, for example, an enumeration protocol, which is an algorithm that can be used to read the address of every electronic chip 30 on one-wire bus 28. Communication module 24 and one-wire bus 28 may utilize a communication protocol similar to the 1-wire device communication bus system designed by Maxim Integrated Company™ Communication module 24 can include software instructions programmed to control communication and write data to or read data from the one or more electronic chips 30.

Transmitter module 26 may interface with communication module 24 and be designed to transmit data to a central database, a computer, a mainframe, or other suitable data storage device or system. For example, transmitter module 26 may be configured to transmit data read from electronic chips 30 by communication module 24. In some embodiments, transmitter module 26 may be integrated into communication module 24. Communication module 24 and transmitter module 26 may be positioned at any suitable location within machine 10.

Electronic chips 30 may be integrated into various types of components 38 for machine 10. In some embodiments, for example, electronic chips 30 may be integrated into the various filters used by machine 10 (e.g., a fuel filter, an oil filter, a hydraulic fluid filter, and a transmission fluid filter). Electronic chips 30 may be integrated into other types of components 38 of machine 10, for example, sensors, work implements, pumps, mufflers, turbochargers, transmissions, engine heads, fuel injectors, and/or the like. Electronic chips 30 may be integrated into components 38 that are disposable or commonly replaced as part of routine maintenance for machine 10.

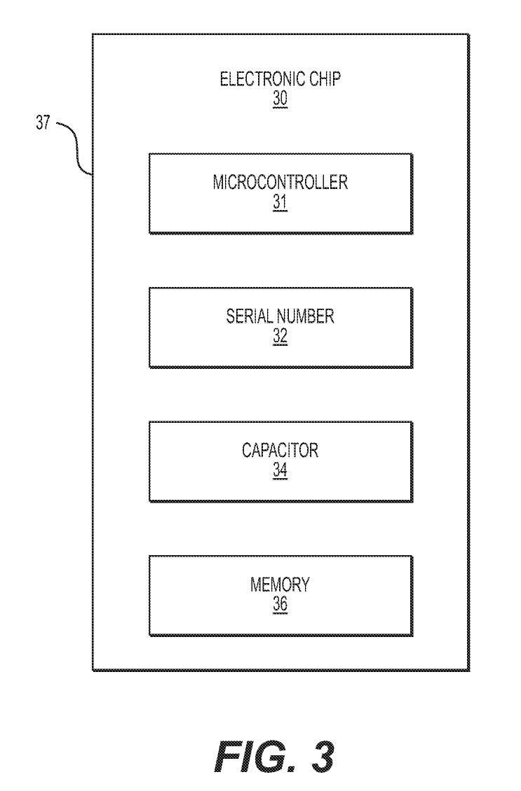

FIG. 3 shows a schematic representation of an exemplary electronic chip 30. It is to be understood that although this description of electronic chip 30 refers to an individual electronic chip 30, it is intended to be equally applicable to any electronic chip 30 that may be integrated into a component 38 for machine 10 and connected to one-wire bus 28 to form a part of tracking system 22. Electronic chip 30 may be, for example, a silicon chip or other suitable type chip. As illustrated in FIG. 3, Electronic chip 30 may include a microcontroller 31 programmed to control the function of electronic chip 30. In some embodiments, microcontroller 31 may be, for example, a read only memory (ROM) function control unit. Electronic chip 30 may also include a serial number 32 (or information identifying serial number 32), which serves as an address on one-wire bus 28 when connected. Serial number 32 may be a unique, unalterable, factory-programmed 64-bit number. Serial number 32 may be laser etched onto electronic chip 30. Electronic chip 30 may also include, among other things, a capacitor 34 and a memory device 36. Capacitor 34 may be configured to store a charge and power electronic chip 30 when data is being sent along one-wire bus 28. Memory device 36 may be any suitable type of writeable and/or readable type of memory (e.g., flash memory). Data may be written to or read from memory device 36 by communication module 24 or a similar device via one-wire bus 28 or a direct connection. In some embodiments, data may be written to or read from memory device 36 by a service technician connected via service connection port 27.

In some embodiments, electronic chip 30 may be enclosed in a protective conductive housing 37, which may protect the internal components of electronic chip 30 from environmental elements while still enabling electronic chip 30 to connect to one-wire bus 28 and ground. In other embodiments, electronic chip 30 may be integrated into a component 38 in such a way that the component 38 itself protects electronic chip 30 from environmental elements while still enabling connection to one-wire bus 28 and ground. The cost of electronic chip 30 may be sufficiently inexpensive that there may be minimal impact to the cost of a component 38 in which electronic chip 30 is integrated. The size of electronic chip 30 may be sufficiently small that there may be minimal impact to the size of a component 38 in which electronic chip is integrated. For example, electronic chip 30 may be less than about 5 millimeters wide, about 5 millimeters long, and about 2 millimeters thick. Electronic chip 30 may utilize similar hardware and software to the iButton® devices manufactured by Maxim Integrated Company™.

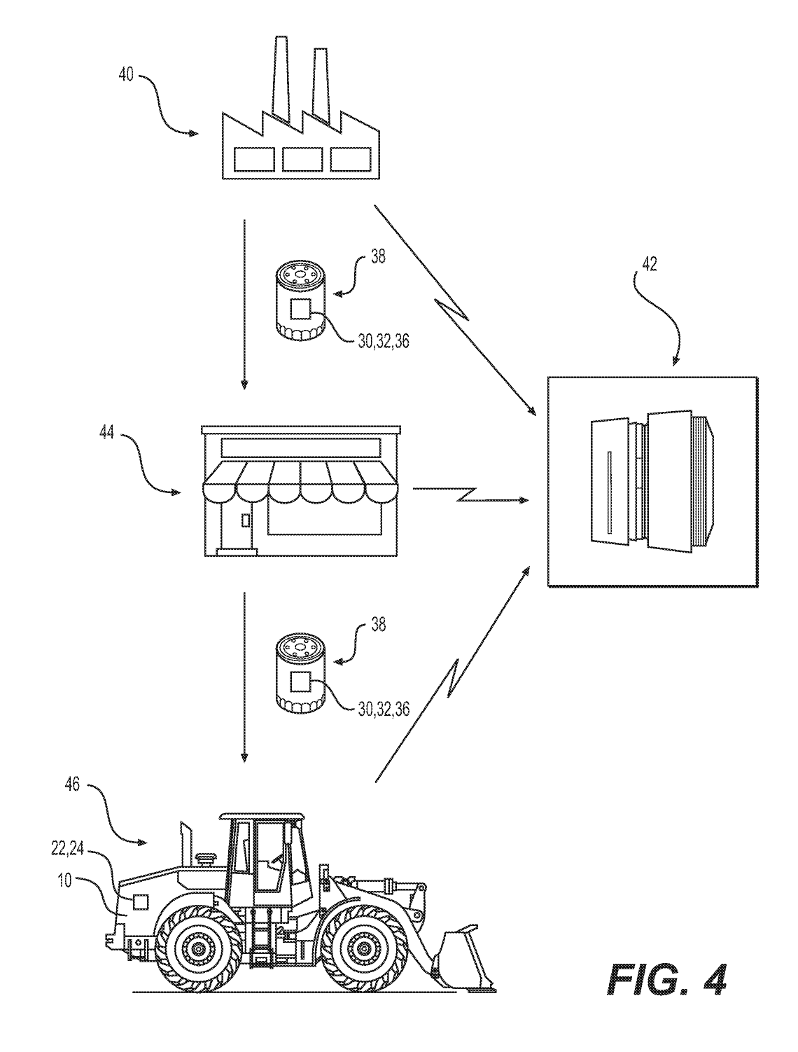

Electronic chips 30 may be used to track components 38 while installed on machine 10 and also prior to being installed on machine 10. According to the present disclosure, electronic chips 30 may be used to track lifecycle for components 38. For example, FIG. 4 illustrates a representative lifecycle for an exemplary component 38. It is to be understood that although the following lifecycle description refers to an individual component 38, electronic chip 30, and serial number 32, it is intended to be equally applicable to a plurality of components 38 each having an electronic chip 30 and serial number 32.

As illustrated in FIG. 4, the lifecycle for component 38 may begin at a manufacturer 40 with the manufacturing of component 38. The manufacturing process for component 38 may include assigning serial number 32 to component 38 by integrating electronic chip 30 having serial number 32 into component 38. In addition to assigning serial number 32 to component 38, additional manufacturing data for component 38 may be associated with the assigned serial number 32 and component 38 as part of the manufacturing process. The manufacturing data may include additional information about component 38, for example, a part number, a date of manufacture, a manufacturer name, a location of manufacture, or other potentially valuable manufacturing information. The manufacturing data may vary depending on the type of component 38 or other factors.

The manufacturing data for component 38 may be associated with the assigned serial number 32, for example, by writing the manufacturing data to memory device 36 of electronic chip 30 or by transmitting the manufacturing data along with serial number 32 to a central database 42, as part of the manufacturing process for component 38. In some embodiments, the manufacturing data may be written to memory device 36 of electronic chip 30 as well as transmitted to central database 42. A communication module 24 or similar device may be connected to electronic chip 30 during the manufacturing process enabling associating of the manufacturing data of component 38 to serial number 32.

As illustrated in FIG. 4, after component 38 is manufactured it may travel along the usual stream of commerce or supply chain from manufacturer 40 to a seller or dealer 44. When component 38 is sold by dealer 44, sales data for component 38 may be associated with serial number 32 of component 38, as part of the sales transaction. The sales data may include, for example, a dealer name, a customer name or end user name, a date of sale, a price of sale, or other potentially valuable sales information. The sales data may vary depending on the type of component 38 or other factors.

The sales data for component 38 may be associated with serial number 32, for example, by writing the sales data to memory device 36 of electronic chip 30 or by transmitting the sales data along with serial number 32 to central database 42. In some embodiments, the sales data may be written to memory device 36 of electronic chip 30 as well as transmitted to central database 42. A communication module 24 or similar device may be connected to electronic chip 30 as part of the sales transaction process enabling associating of the sales data for component 38 to serial number 32.

As illustrated in FIG. 4, component 38 may travel further along the usual stream of commerce or supply chain from dealer 44 until it makes its way to an end user 46. End user 46 may be, for example, a machine owner, operator, or technician that installs component 38 on machine 10 and connects it to tracking system 22. When component 38 is installed on machine 10, end user data may be associated with serial number 32 of electronic chip 30 assigned to component 38, as part of or subsequently to the installation. The end user data may include, for example, a service technician identifier (e.g., for the service technician that installed the component), a date of installation, an end user name, a machine identifier for machine 10, or other potentially valuable end user or machine information. The end user data may vary depending on the type of component 38, machine 10, end user 46 or other factors. The end user data for component 38 may be associated with serial number 32, for example, by writing the end user data to memory device 36 of electronic chip 30 as part of the installation procedure or by transmitting the manufacturing data along with serial number 32 to central database 42 causing the central database to associate serial number 32 and component 38 to machine 10. In some embodiments, the end user data may be written to memory device 36 of electronic chip 30 as well as transmitted to central database 42. Communication module 24 of tracking system 22 may be connected to electronic chip 30 once installed on machine 10 and the installation process may include associating the end users data to serial number 32.

In some embodiment, end user data for component 38 associated with serial number 32 may be updated over time. For example, in some embodiments, end user data may be routinely updated so it can be tracked whether component 38 is still connected and in use. For some embodiments, end user data may be updated routinely until component 38 is replaced and the end user data may then be updated a final time with a removal date. In some embodiments, operation and/or diagnostic information for machine 10 may be transmitted by tracking system 22 or other system of machine 10 to central database 42 and associated with serial number 32.

It is contemplated that there may be greater or fewer parties that may handle component 38 as it travels along the usual stream of commerce or supply chain from manufacturer 40 to end user 46. FIG. 4 is only meant to be an illustrative example, because for some embodiments, additional parties (e.g., a shipper, a distributor, an inspector, and others) may handle component 38 and may associate additional data to serial number 32 assigned to component 38. These additional parties may also associate additional data to serial number 32 of component 38 by writing the additional data to memory device 36 of electronic chip 30 or by transmitting the additional data along with serial number 32 to central database 42.

### INDUSTRIAL APPLICABILITY

Tracking system 22, as described herein may be utilized for methods of tracking components 38 of machine 10. The methods may include connecting electronic chips 30 to communication module 24 via one-wire bus 28, wherein electronic chips 30 have serial numbers 32 and are integrated with components 38 of machine 10. The methods may further include reading serial numbers 32 of electronic chips 30 via communication module 24 and transmitting serial numbers 32 to central database 42 via transmitter module 26, which is operatively connected to the communication module 24, causing central database 42 to associate serial numbers 32 and components 38 to machine 10. These methods may further include reading data saved to electronic chips 30 and transmitting the data to central database 42. This data may include manufacturing data, sales data, and end user data for components 38. This method of tracking components 38 of machine 10 may be used to track one or a plurality of components 38 installed on machine 10.

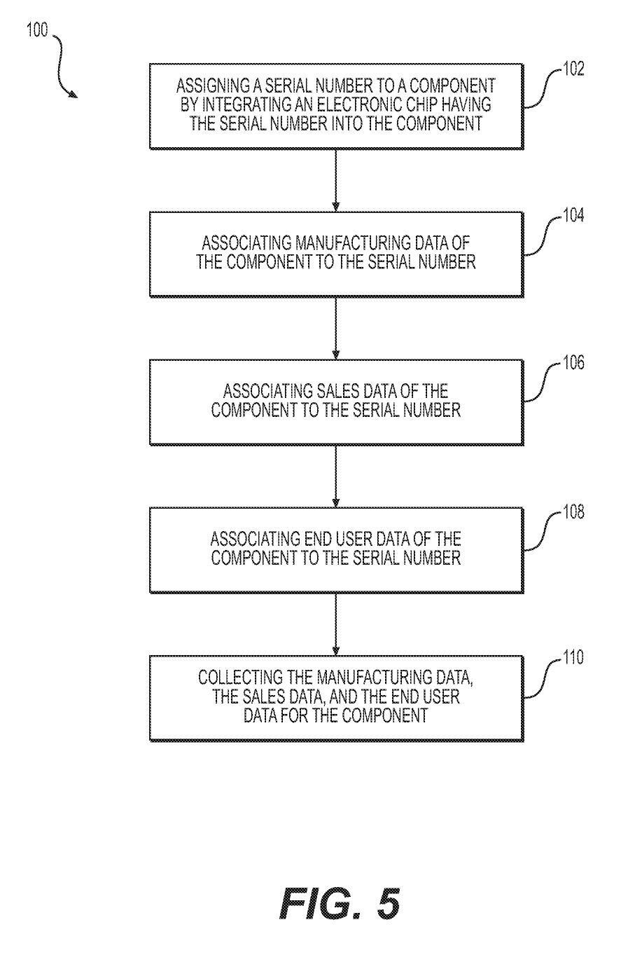

FIG. 5 is a flow chart illustrating an exemplary method 100 for tracking the lifecycle of a component 38 for a machine 10. It is to be understood that although this description of method 100 refers to an individual component 38, it may be applied for tracking a plurality of different components, manufactured by a plurality of different manufacturers, sold by a plurality of different dealers, installed on a plurality of different machines, by a plurality of different end users.

Method 100 may begin by assigning serial number 32 to component 38 by integrating electronic chip 30 having serial number 32 into component 38 (Step 102). For some embodiments, step 102 may be performed as part of the manufacturing process for component 38. Method 100 may further include associating manufacturing data of component 38 to serial number 32 (Step 104), which may be part of the manufacturing process for component 38. For some embodiments, associating the manufacturing data of component 38 to serial number 32 may include writing the manufacturing data to electronic chip 30, transmitting the manufacturing data along with serial number 32 to central database 42 where the manufacturing data can be saved with serial number 32, or a combination of both.

For some embodiments, method 100 may further include associating sales data of component 38 to serial number 32 (Step 106). For some embodiments, step 106 may be part of the sales transaction for component 38. For some embodiments, associating the sales data of component 38 to serial number 32 may include writing the sales data to electronic chip 30, transmitting the sales data along with serial number 32 to central database 42 where the sales data can be saved with serial number 32, or a combination of both.

Method 100 may further include associating end user data of component 38 to serial number 32 (Step 108). For some embodiments, step 108 may be part of the installation process of component 38 on machine 10. For some embodiments, associating the end user data of component 38 to serial number 32 may include writing the end user data to electronic chip 30, transmitting the end user data along with serial number 32 to central database 42 where the end user data can be saved with serial number 32, or a combination of both.

Method 100 may further include collecting the manufacturing data, the sales data, and the end user data for component 38, causing central database 42 to associate serial number 32, the manufacturing data, the sales data, and the end user data with machine 10 (Step 110). For some embodiments, the manufacturing data, the sales data, and the end user data may be collected and saved in memory device 36 of electronic chip 30 or collected and saved in central database 42. The manufacturing data, the sales data, and the end user data for component 38 may form lifecycle data for component 38.

Central database 42 may be designed to collect and save lifecycle data for a plurality of components, for a plurality of different machines, from a plurality of manufacturers, dealers, and end users. Central database 42 may be maintained by multiple parties or a single party, for example, a manufacturer of the machine, which in some cases may also be the manufacturer of the components. This collection of lifecycle data or a portion of the lifecycle data may be selectively shared with manufactures, dealers, and end users. The collection of lifecycle data may be sorted, grouped, and searched by manufacturers, dealers, and end users in different ways to provide insight and produce potentially valuable information (e.g., marketing, sales, and/or service information).

A manufacturer, for example, may search the lifecycle data for one or more of the components it has manufactured in order to identify various pieces of information, which may be of value to the manufacturer. For example, a manufacturer may identify what dealers are selling their components and what dealers are not, what end users are buying their components and what end users are not, and what machines are the components being used for. In another example, a manufacturer may identify when a component was sold and how long the component was in service.

A dealer, for example, may access the lifecycle data and identify various pieces of information, which may be of value to the dealer. For example, a dealer may identify what machines an end user owns and what components for the machine the end user is buying from the dealer and what components the end user is not. The dealer may use this information in order to identify which customers and end users to target with what components. A dealer may use the lifecycle data to provide enhanced service to end users, for example, by forecasting when an end user is going to need a replacement component based on purchase history and informing the end user of the upcoming need.

An end user, for example, may access the lifecycle data and search and identify various pieces of information, which may be of value to the end user. For example, an end user may search the lifecycle data by a machine identifier in order to identify all the components installed on the machine or components that have been installed on the machine. An end user may also search the lifecycle data by their end user name in order to identify all the components they have purchased. This purchase information may then be further sorted to identify, for example, all components not yet installed, which could be used by an end user to identify or cross-reference their inventory.

In some embodiments, the lifecycle data may be utilized in conjunction with other operational and/or diagnostic data (e.g., a machine location, a machine speed, an engine run time, an engine temperature, warnings and/or faults, pressure levels, fluid levels, and the like) for a machine collected by central database 42, to determine and track a maintenance schedule for the machine. For example, a date of installation for a component along with operational data for the machine may be used to determine a replacement date for the component. The lifecycle data may then be used by, for example, machine 10 or central database 42 to monitor whether the component was replaced on the replacement date and if it was not then an end user may be alerted. Often replacement frequency for components is based on a machine engine run time, but this may not always be the most accurate metric of actual usage or wear on a component so utilizing the lifecycle data along with other operational and/or diagnostic data collected can help optimize the replacement frequency for components.

Machine specific maintenance schedule may also be developed and tracked utilizing the methods described herein. For example, the lifecycle data for multiple components used on an individual machine may be collected and analyzed to determine the frequency and severity of the machine's use and based on this may determine a maintenance schedule (e.g., heavy duty maintenance schedule or light duty maintenance schedule) and replacement frequency for the components in or to maximize component life while optimizing machine performance. The replacement of the components may be tracked using the tracking system described herein, in order to monitor and ensure the components are being replaced according to the specific maintenance schedule developed for the machine.

In some embodiments, the lifecycle data may be utilized by the machine and/or central database to identify counterfeit components. For example, if a serial number and part number for a component is transmitted to the central database when a component is sold by a dealer or installed by an end user and the part number transmitted with the serial number does not match the original part number established and associated with the serial number when the component was manufactured, then the component may be identified as counterfeit by the machine and/or central database. It is contemplated, that the disclosed systems and methods of tracking the lifecycle of a component may be utilized in other ways to identify counterfeit components or other fraudulent activities.

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented. Other embodiments will be apparent to those skilled in the art from consideration of the specification and practice of the disclosed concepts. It is intended that the specification and examples be considered as exemplary only, with a true scope being indicated by the following claims and their equivalents.

What is claimed is:

1. A system for tracking components of a machine, comprising:
an electronic chip having a serial number, wherein the electronic chip is integrated within a component of the machine;
a communication module operatively connected to the electronic chip via a communication bus; and
a transmitter module operatively connected to the communication module;
wherein the communication module reads the serial number of the electronic chip and the transmitter module transmits the serial number to a central database, causing the central database to associate the serial number and the component to the machine.

2. The system of claim 1, wherein the component of the machine is at least one of a fuel filter, an oil filter, an air filter, a hydraulic fluid filter, a transmission fluid filter, a sensor, a work implement, a pump, a turbocharger, a transmission, an engine head, and a fuel injector.

3. The system of claim 1, further comprising a plurality of electronic chips each having a serial number, wherein the electronic chips are each integrated with a different component of the machine and the communication module is operatively connected to the plurality of electronic chips via the communication bus.

4. The system of claim 1, wherein data is saved on the electronic chip and the communication module reads the data and transmits the data to the central database.

5. The system of claim 4, wherein the data includes at least one of manufacturing data, sales data, and end user data.

6. The system of claim 5, wherein the manufacturing data for the component includes at least one of a part number, a date of manufacture, a manufacturer name, and a location of manufacture.

7. The system of claim 5, wherein the sales data for the component includes at least one of a dealer name, an end user name, or a date of sale.

8. The system of claim 5, wherein the end user data for the component includes at least one of a date of installation, a service technician identifier, or a machine identifier for the machine.

9. The system of claim 1, wherein the central database receives data associated with the serial number that is provided by at least one of a manufacturer that manufactured the component, a dealer that sold the component, or an end user that installed the component in the machine.

10. A method for tracking the lifecycle of a component for a machine, the method comprising:
assigning a serial number to the component by integrating an electronic chip having the serial number into the component;
associating manufacturing data of the component to the serial number as part of the manufacturing process for the component;
associating end user data of the component to the serial number as part of the installation process for the component; and
collecting the manufacturing data and the end user data of the component in a central database, causing the central database to associate the serial number, the manufacturing data, and the end user data with the machine.

11. The method of claim 10, further including associating sales data of the component to the serial number as part of the sale transaction for the component, wherein the manufacturing data, the sales data, and the end user data of the component is combined to form lifecycle data for the component.

12. The method of claim 11, further comprising selectively sharing the lifecycle data with at least one of the manufacturer, the dealer, and the end user of the component.

13. The method of claim 11, further comprising determining and tracking a maintenance schedule for the machine based on the lifecycle data.

14. The method of claim 11, further comprising using the lifecycle data of the component to identify if the component is a counterfeit.

15. The method of claim 10, wherein associating the manufacturing data of the component to the serial number includes at least one of writing the manufacturing data to the electronic chip and transmitting the manufacturing data along with the serial number to the central database, which saves the manufacturing data with the serial number.

16. The method of claim 11, wherein associating the sales data of the component to the serial number includes at least one of writing the sales data to the electronic chip or transmitting the sales data along with the serial number to the central database, which saves the sales data with the serial number.

17. The method of claim 10, wherein associating the end user data of the component to the serial number includes at least one of writing the end user data to the electronic chip or transmitting the end user data along with the serial number to the central database, which saves the end user data with the serial number.

18. A method for tracking components of a machine, the method comprising:
connecting an electronic chip to a communication module via a communication bus, wherein the electronic chip has a serial number and is integrated with a component of the machine; and
reading the serial number of the electronic chip via the communication module and transmitting the serial number to a central database via a transmitter module that is operatively connected to the communication module, causing the central database to associate the serial number and the component to the machine.

19. The method of claim 18, wherein the electronic chip includes at least one of manufacturing data, sales data, and end user data saved to the electronic chip and the communication module reads the data and transmits the data to the central database.

20. The method of claim 18, further comprising the central database receiving data associated with the serial number that is provided by at least one of a manufacturer that manufactured the component, a seller that sold the component, and an end user that installed the component on the machine.
